(19) United States
(12) Patent Application Publication
(10) Pub. No.: US 2025/0179611 A1
(43) Pub. Date: Jun. 5, 2025

(54) METHOD FOR PROCESSING ZINC CONCENTRATES

(71) Applicant: GLENCORE TECHNOLOGY PTY LIMITED, Queensland (AU)

(72) Inventors: Alistair Stewart BURROWS, Brisbane (AU); Stanko NIKOLIC, Brisbane (AU)

(21) Appl. No.: 18/839,244

(22) PCT Filed: Feb. 10, 2023
(86) PCT No.: PCT/AU2023/050086

§ 371 Date: Aug. 16, 2024

(30) Foreign Application Priority Data
Feb. 16, 2022 (AU) 2022900328

(51) Int. Cl. C22B 19/00; C22B 5/04; C22B 15/00

(52) U.S. Cl. CPC C22B 19/00; C22B 5/04; C22B 15/0054

(57) ABSTRACT

According to the present invention there is provided a method for smelting a zinc sulfide concentrate, the method comprising the steps of: feeding the zinc sulfide concentrate to a reduction furnace at a known mass flow rate of sulfur; feeding copper metal to the reduction furnace at a mass flow rate of copper approximately three-times the mass flow rate of sulfur; reducing the zinc sulfide to zinc according to the equation ZnS₍ₗ₎+2Cu₍ₗ₎→Cu₂S₍ₗ₎+Zn_{(g)}; and fuming the zinc; wherein sulfur is absorbed into the copper metal in the reduction furnace to form a copper sulfide molten matte. The partial pressure of SO₂ in the furnace is maintained below about 10⁻³ atm and the reduction furnace is operated at a temperature of between about 1240 and about 1300° C.

### FIELD OF THE INVENTION

The present invention relates to a method for processing zinc concentrates. More specifically, the present invention relates to a method for processing zinc sulfide concentrates. Although the present invention will be described hereinafter with reference to its preferred embodiment, it will be appreciated by those of skill in the art that the spirit and scope of the invention may be embodied in many other forms.

### BACKGROUND OF THE INVENTION

Any discussion of the prior art throughout the specification should in no way be considered as an admission that such prior art is widely known or forms part of common general knowledge in the field.

Zinc metal is typically obtained by treating sulfide materials that contain zinc. In a widely used process, the sulfide materials are first roasted to convert zinc sulfide to zinc oxide, in accordance with the following reaction (1):

2ZnS+3O_{2(g)}→2ZnO+2SO_{2(g)} (1)

A very large percentage of the world's roasting processes are sensitive to the size of the particles in the roaster. Reactions that cause agglomeration of fluidised particles, or reactions that cause sintering of particles (the particles being either at rest or in suspension), are unwanted reactions in a roaster. For this reason, current technologies for roasting zinc are sensitive to the presence of unwanted compounds in the zinc sulfide concentrate that will cause agglomeration or sintering reactions inside the roaster. Two such compounds that may exist in zinc sulfide concentrates are SiO₂ and PbS.

Inside prior art zinc roasters, the temperature is typically in the range 900-960° C., which is a thermodynamically-constrained range suitable for maximising the formation of ZnO, minimising the formation of ZnSO₄ and minimising the formation of ZnFe₂O₄ in the calcine. At this temperature, a sequence of reactions (2) and (3) is possible, and the tiny amounts of liquid thereby formed are thought to contribute to the problem of agglomeration and sintering.

2PbS+3O_{2(g)}→2PbO+2SO_{2(g)} (2)

2PbO+SiO₂→Pb₂SiO₄₍ₗ₎ (3)

To avoid the problems of agglomeration and sintering reactions in zinc roasters, commercially-traded zinc sulfide concentrates tend to contain less than 10% SiO₂ or 10% PbS and are much preferred to contain less than 5% SiO₂ or 5% PbS. A vast amount of mined ore is discarded by plants devoted to mineral processing, so that the compounds of SiO₂ and PbS are rejected, thereby purifying the zinc sulfide concentrates to suit zinc roasters. The corollary is that some zinc ore deposits lie yet unexploited because no zinc sulfide concentrate can be made from them with suitably low contents of SiO₂ and PbS.

Smelting provides a solution to many of the problems that roasters have when processing zinc sulfide concentrates containing generous amounts of SiO₂ and PbS.

In WO 91/08317, smelting of sulfide zinc concentrates was described by a method involving fuming of zinc from a bath containing molten oxides (i.e., slag). A similar process is described in AU 200244352. These processes go on to differ in their approach to capturing the zinc values in the fume, but their smelting steps are substantially similar. Both rely to a large extent on the simplified chemical reaction shown in (4)

ZnS+O_{2(g)}→SO_{2(g)}+Zn_{(g)} (4)

This reaction is direct and in its simplicity it is appealing but, as implied by FIG. 1, attempts to simultaneously achieve these two gaseous species is subject to an awkward thermodynamic constraint. As the partial pressure of SO₂ increases, the partial pressure of zinc vapour decreases. The practical consequence of this thermodynamic constraint is that a gas with high SO₂ concentration suitable for an acid plant can be made only in a furnace that does not fume a high percentage of input zinc out of the molten materials.

The inventions in both WO 91/08317 and AU 200244352 suffer from the further disadvantage that most of the lead present as PbS in the zinc sulfide concentrate will report to the fume along with the zinc, which increases the difficulty for making a purified zinc product.

In both U.S. Pat. No. 5,372,630 and WO 88/01654, it was described how zinc could be fumed effectively out of a zinc sulfide concentrate, with comparatively modest amount of reductant, if the smelting were done with vigorous stirring inside a furnace containing an iron sulfide matte phase. Among the differences in the processes were that U.S. Pat. No. 5,372,630 taught that the iron sulfide matte should be dispersed and intimately mixed into a slag phase, while WO 88/01654 taught that the slag should overlay the iron sulfide matte phase. If this smelting step were to be done with a submerged lance process, as described by the inventors, such a design is problematic because those skilled in the art understand that hot iron sulfide matte is well known for accelerating the corrosion of submerged lances. Perhaps this type of process may be implementable as research project, but owing to the impossible material constraints it imposes on the lances it becomes unviable at a commercial scale.

In U.S. Pat. No. 5,443,614, it was described how zinc could be fumed effectively from a furnace into a gas containing a low SO₂ concentration. The inventors of this process realised that using a metal to absorb the contained S within the zinc sulfide concentrate would create an environment with low partial pressure of SO₂, which is thermodynamically favourable for zinc fuming. In their process metallic iron enters the smelting furnace as a feed material, and absorbs sulfur from the zinc sulfide concentrate, to create a molten iron sulfide matte and a zinc fume. The inventors reasoned that disposing of the iron sulfide matte thereby produced would be preferable to creating a sulfuric acid plant and handling large volumes of SO₂ gases. In disposing of the iron sulfide matte, the inventors of this process have saddled it with a commercial disadvantage, because precious metals that may exist in the original zinc sulfide concentrate will be dissolved into the iron matte with no easy way for recovery therefrom. Silver, in particular, is commonly found in zinc sulfide concentrates and a means of silver recovery is essential for the commercial viability of a smelter.

In U.S. Pat. No. 4,334,918 it was described how circulation of molten copper sulfide matte could be used to digest zinc sulfide concentrates and could be used for the transport of heat energy so that heat generated by exothermic reactions could be harvested and used at other reaction sites by endothermic reactions. According to the invention, the locations for zinc sulfide addition, zinc recovery and SO₂ generation are separated from each other. The inventor envisaged zinc fume forming endothermically by the reaction (5).

ZnS₍ₗ₎+2Cu₍ₗ₎→Cu₂S₍ₗ₎+Zn_{(g)} (5)

This version of the invention required exothermic regeneration of the copper metal, along with SO₂ gas and slag, in an oxidation zone. Recirculation of the copper metal to contact matte pregnant with zinc sulfide would then allow further fuming of zinc. The inventor's subsequent experience in a pilot plant showed this concept to be disadvantageous owing to the well-known engineering problem of inefficient heat generation when trying to inductively heat a furnace containing large amounts of copper metal. Practical experience forced the inventor to re-think his invention.

In U.S. Pat. No. 5,358,544, an improvement on the invention in U.S. Pat. No. 4,334,918, it was described how the same concept of recirculating copper sulfide matte could be used to digest zinc sulfide concentrate and to transport heat energy, but that copper should be maintained below unit activity in the oxidation zone. The implication is that sufficient zinc will fume sufficiently fast from the pregnant matte by the action of a vacuum de-gasser and there is no need for reaction (5) to make the process operate successfully.

While these points may indeed be improvements to the previous invention, the inventor neglected to mention the practical disadvantages that would exist from recirculation of so much copper matte as would be needed. In order to practically realise the claimed energy advantages of the process, absorption of the enthalpy released from generation of SO₂ and slag must be achieved while maintaining normal smelting temperatures. The process has been calculated to require 100 tonnes of recirculating Cu₂S for every tonne of recovered zinc, rendering the engineering of a smelter impractical at the typical commercial scale of an industrial zinc plant (i.e., more than 20 tonnes per hour of refined zinc).

In U.S. Pat. No. 5,403,380 it was described how hot molten copper could be used as a sulfur transport medium, so that zinc sulfide concentrate could be added to a furnace, zinc fume could be generated with simultaneous formation of some copper sulfide matte according to reaction (5), and then the copper sulfide matte could be later converted to blister copper in a separate furnace and recirculated back to absorb more sulfur during further contact with zinc sulfide concentrate. The arrangement of furnaces is shown schematically in FIG. 2. The inventors of this process claimed that a key part of their invention was the operation of the reduction furnace at temperatures exceeding 1450° C. and recovery of produced zinc vapour in metallic form. It is well known that high temperatures assist with fuming of zinc, and it is also clear that direct recovery of metallic zinc is a desirable goal, but both conditions impose onerous engineering burdens on the design of the reduction furnace. If treating a zinc sulfide concentrate with a relatively high content of PbS at the stated temperatures it is clear that this method of smelting will recover a greater proportion of the Pb derived from PbS to the zinc fume, thus reducing the purity of the zinc product. It is also clear that if treating a zinc sulfide concentrate with a relatively high content of SiO₂ this method of smelting will unavoidably make some form of slag in the reduction furnace, which is not disclosed in the invention and could be problematic. Molten slag, rich in SiO₂ is known to be a good solvent for ZnO and might therefore decrease the efficiency of the invention if the reduction furnace were to smelt SiO₂-rich zinc sulfide concentrates.

It is an object of the present invention to overcome or ameliorate at least one of the disadvantages of the prior art, or to provide a useful alternative.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Although the invention will be described with reference to specific examples it will be appreciated by those skilled in the art that the invention may be embodied in many other forms.

### SUMMARY OF THE INVENTION

The present invention is directed to a method for smelting zinc sulfide concentrate, which may at least partially overcome at least one of the abovementioned disadvantages or provide the consumer with a useful or commercial choice.

This, according to a first aspect of the present invention there is provided a method for smelting a zinc sulfide concentrate, the method comprising the steps of:
feeding the zinc sulfide concentrate to a reduction furnace at a known mass flow rate of sulfur;
feeding copper metal to the reduction furnace at a mass flow rate approximately three-times the mass flow rate of sulfur;
reducing a substantial proportion of the zinc sulfide to zinc; and
fuming the zinc;
wherein sulfur is absorbed into the copper metal in the reduction furnace to form a copper sulfide molten matte.

As zinc sulfide is reduced to zinc metal in the furnace, throughout this specification, this furnace will be referred to as the reduction furnace or the reducing furnace.

In one embodiment, the partial pressure of SO₂ in the furnace is maintained below 10⁻³ atm, with the incoming sulfur (in the zinc sulfide concentrate) absorbed by the copper metal to continuously form copper sulfide matte. In this manner, a higher partial pressure of zinc and more favourable conditions for fuming zinc thereby be promoted.

In one embodiment, the method comprises removing a molten matte from the furnace. The molten matte may be sent to a copper converting furnace or furnaces. In one embodiment, the molten matte comprises the copper sulfide matte. In this embodiment of the invention, the copper converting furnace(s) may regenerate copper metal and continually resupply a flow of copper metal into the reduction furnace. The copper metal regenerated in the copper converting furnace(s) will typically be a blister copper and the blister copper may be returned to the reduction furnace.

In one embodiment, the molten material in the furnace comprises a mixture of molten slag and molten matte. In this embodiment, the mixture of molten slag and molten matte is removed from the furnace and sent to a settling furnace, and the molten slag is removed from the settling furnace, and molten matte is removed from the settling furnace and sent to a copper converting furnace or furnaces. The molten matte may be sent to a copper converting furnace(s) and treated as described in the paragraph immediately above.

In another embodiment, the molten matte is removed from the settling furnace and sent to a remote copper smelter or sold to a remote copper smelter. Again, it will be appreciated that, in practice, typically a molten mixture of molten slag and molten matte will be removed from the reduction furnace and sent to a settling furnace, and the molten slag is removed from the settling furnace and the molten matte is removed from the settling furnace. In this embodiment of the invention, the furnace to which the zinc sulfide concentrate is added will need to be supplied with a feed of copper metal from another source.

In one embodiment, the copper metal that is added to the smelter comprises copper scrap. The term “scrap copper” or “copper scrap” is intended to comprise both high grade and low grade copper scrap, for example, No. 1 and No. 2 copper scrap, auto-shred residue (ASR), waste electrical and electronic equipment, E-scrap, brass, bronze, No. 1 and No. 2 insulated wires, bare bright copper, copper alloy scraps and the like. In another embodiment, the copper metal that is added to the smelter comprises blister copper that is formed from the molten matte that is removed from the furnace. The copper metal that is added to the reduction furnace may be in the form of a solid or in the form of molten copper.

In one embodiment, the zinc that is formed in the reduction furnace from the zinc sulfide concentrate is formed according to reaction (5), as given above.

The matte formed in the reduction furnace may suitably contain between 65 to 75% copper. Advantageously, precious metals in the zinc sulfide concentrate (including gold and silver) will report to the matte and can be, from time to time, separately recovered in downstream processes of normal copper smelting and refining plants that will be familiar to those skilled in the art. Advantageously, much of the lead present as PbS in the zinc sulfide concentrate will report to the copper matte phase. The deportment of PbS to the matte phase is dependent on both the reduction furnace temperature and the slag composition, but is in the vicinity of 60% of the total incoming PbS mass. The practical result of this is that a Pb-rich fume will be produced from the copper converting furnace, which minimises the Pb contamination in the ZnO fume produced by the reduction furnace.

In one embodiment, the reduction furnace comprises a top-blown submerged-combustion lance furnace, commonly known as a TSL furnace. An example of such a suitable furnace is one available from the present applicant and sold under the trademark ISASMELT™.

In one embodiment, the converting furnace comprises a top-blown submerged-combustion lance furnace, commonly known as a TSL furnace. An example of such a suitable furnace is one available from the present applicant and sold under the trademark ISACONVERT™.

In one embodiment, the reduction furnace is operated at an oxygen partial pressure between 10^{-10.5} and 10⁻⁹ atm. In one embodiment, air, oxygen, or oxygen-enriched air is added to the furnace in the correct ratios as may be required to maintain the furnace atmosphere with the target oxygen partial pressure.

In one embodiment, the reduction furnace is operated at a temperature of less than 1300° C., or less than 1280° C. In one embodiment, the reduction furnace is operated at a temperature of from 1240-1300° C., or from 1260-1280° C. The choice of operating temperature can control outputs of the method. Higher operating temperatures promote more complete recovery of zinc to the ZnO fume of the reduction furnace, but reduced temperature improves the purity of the ZnO fume by minimising the presence of Pb in the fume that originates from the PbS in the zinc concentrate.

In one embodiment, a slag is formed in the reduction furnace. The slag may contain between 5 to 25% zinc, or more suitably from 10 to 15% zinc, when the slag leaves the reduction furnace. Such slag is suitable for further processing and recovery of zinc in a slag fuming furnace, as will be well understood by those skilled in the art.

Throughout this specification, all percentages are given as weight percentages.

In one embodiment, the zinc sulfide concentrate that is fed to the furnace may comprise 35 to 60% zinc, up to 5% copper, 2 to 15% lead, 2 to 10% iron, 25 to 35% sulfur, up to 3% calcium oxide, 2 to 10% silica, up to 0.1% silver and up to 0.01% gold.

The process of the present invention is anticipated to be able to treat zinc sulfide concentrates having higher lead and silica contents than can be treated using conventional roasting processes.

According to a second aspect of the present invention there is provided an apparatus for smelting a zinc sulfide concentrate, the apparatus comprising:
means for feeding the zinc sulfide concentrate to a reduction furnace at a known mass flow rate of sulfur;
means for feeding copper metal to the reduction furnace at a mass flow rate approximately three-times the mass flow rate of sulfur;
means for reducing the zinc sulfide to zinc; and
means for fuming the zinc;
wherein sulfur is absorbed into the copper metal in the reduction furnace to form a copper sulfide molten matte.

In an embodiment, the apparatus described above is used for performing the method of the first aspect of the present invention.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 shows a predominance area diagram for the zinc-sulfur-oxygen system at 1300° C.

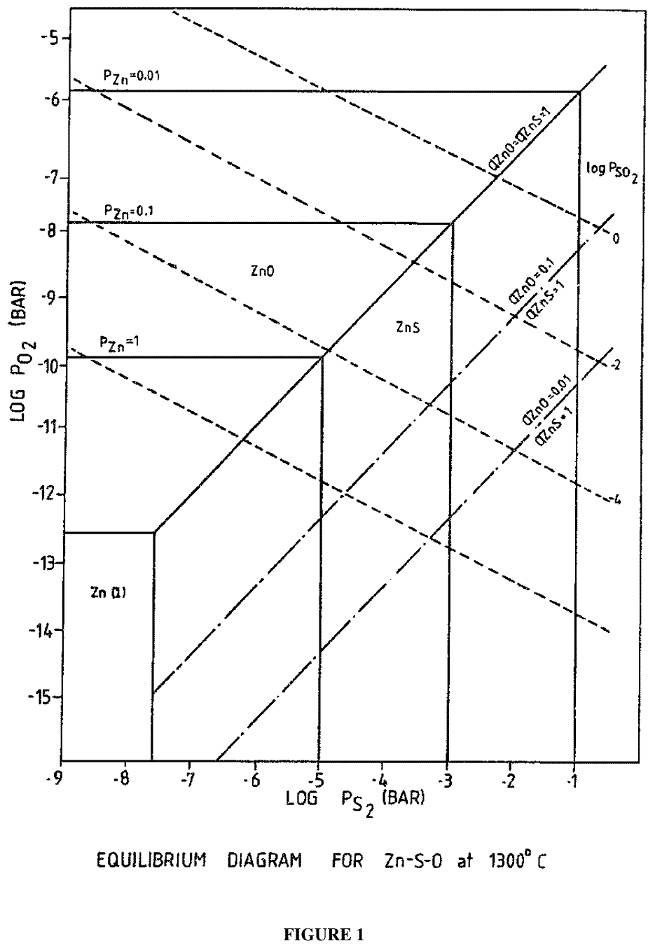

FIG. 2 shows an arrangement of furnaces for production of zinc fume according to the invention described in U.S. Pat. No. 5,403,380.

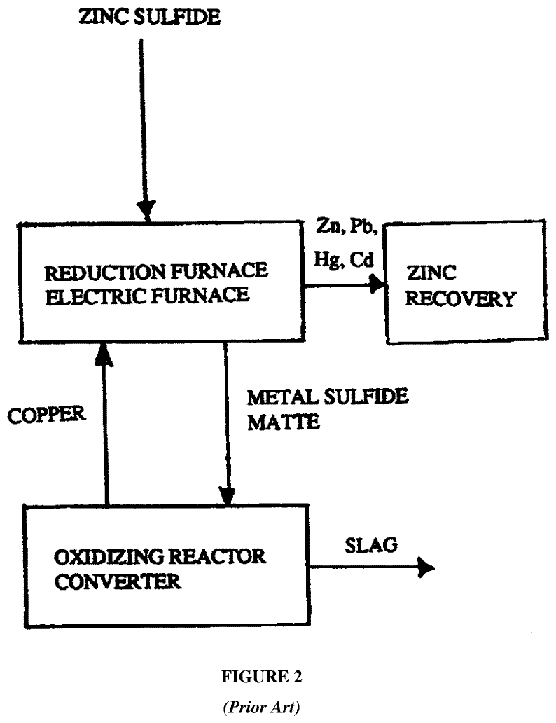

FIG. 3 shows a flowsheet of a method in accordance with one embodiment of the present invention in which molten copper is continually supplied into the reduction furnace. As described, the copper can be resupplied following refinement of the copper sulfide molten matte and/or supplied from another one or more sources.

FIG. 4 shows a flowsheet of a method in accordance with another embodiment of the present invention in which scrap copper is continually supplied into the reduction furnace. In this embodiment, the copper removed from the reduction furnace following periodic extraction of the copper sulfide molten matte may be on-sold to a copper refinery or the like.

### DESCRIPTION OF A PREFERRED EMBODIMENT OF THE INVENTION

The skilled person will understand that the drawings have been provided for the purposes of illustrating preferred embodiments of the present invention. Therefore, it will be appreciated that the present invention should not be considered to be limited solely to the features as shown in the attached drawings.

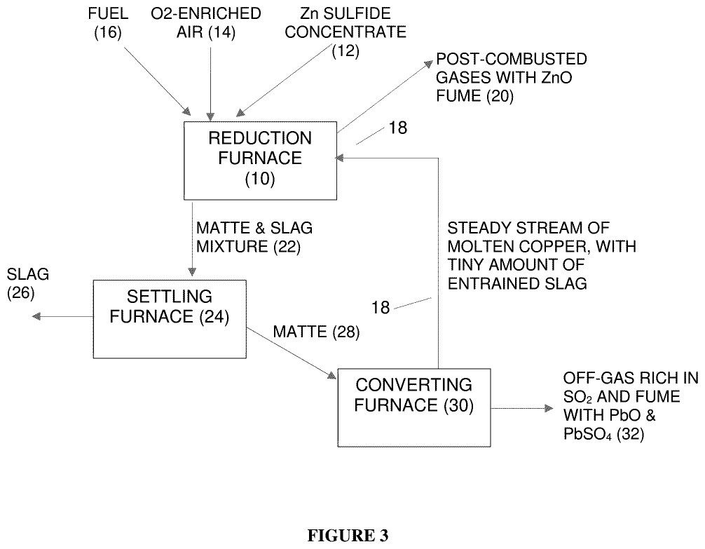

FIG. 3 shows a flowsheet in accordance with one embodiment of the present invention. In FIG. 3, a reduction furnace 10, which comprises a top entry submerged lance furnace sold by the present applicant under the trademarks ISASMELT™ and ISACONVERT™ is fed with a zinc sulfide concentrate 12, air or oxygen enriched air 14, fuel (which may be pulverised coal or oil) 16 and molten copper 18. The furnace 10 is operated at a temperature below 1300° C., such as at a temperature of from 1260-1280° C. The oxygen partial pressure within the furnace 10 is controlled to be less than 10⁻⁹ atm. The mass flow rate of sulfur in the zinc sulfide is approximately one-third that of the mass flow rate of copper.

In the furnace 10, the zinc sulfide reacts with copper metal to form zinc metal and copper sulfide. The zinc metal fumes under the operating conditions of the furnace 10 and is removed with the flue gases 20. After the zinc metal fumes have left the furnace bath and are travelling out of the furnace they may be post-combusted without detriment to the chemical composition of the underlying bath.

A molten phase is also formed in the reduction furnace 10. The molten phase will comprise a molten matte and a molten slag. Due to the vigorous agitation that takes place in the furnace 10, the molten matte and the molten slag are at least partially mixed together. The molten phase is removed at 22 and sent to a settling furnace 24. The settling furnace is operated under relatively quiescent conditions and at a temperature that maintains the slag and the matte in molten state. There the slag will separate from the matte, with the slag typically collecting on top of the matte in the settling furnace. The slag 26 is removed and the matte 28 is also removed from the settling furnace 24. The matte 28 is sent to a copper converting furnace 30.

In one embodiment, the copper converting furnace 30 comprises a top entry submerged lance furnace sold by the present applicant under the trademark ISACONVERT™ The copper converting furnace 30 is operated under known conditions to form blister copper from the copper sulfide matte 28. The blister copper 18 is returned to the reduction furnace 10 to ensure that a continuous supply of molten copper metal is provided to the reduction furnace 10. The blister copper 18 generally comprises a small amount of entrained slag. An off gas 32 that is rich in sulfur dioxide and contains a fume containing lead oxide and lead sulfate is also removed from the converting furnace 30. This off gas may be sent to an acid plant.

According to the invention, typical zinc sulfide concentrates that may form part of the feed to the reduction furnace 10 have the following range of compositions:

| Species | Zn | Cu | Pb | Fe | S | CaO | SiO₂ | Ag | Au |
|---|---|---|---|---|---|---|---|---|---|
| Wt. % | 35-60 | 0-5 | 2-15 | 2-10 | 25-35 | 0-3 | 2-10 | 0-0.1 | 0-0.01 |

In general terms, that the molten matte produced in the reduction furnace will contain about 65-75 wt. % Cu and about 18-22 wt. % S. Other proportions in the respective output compositions are sensitive to the compositions of the inputs, which are themselves flexible.

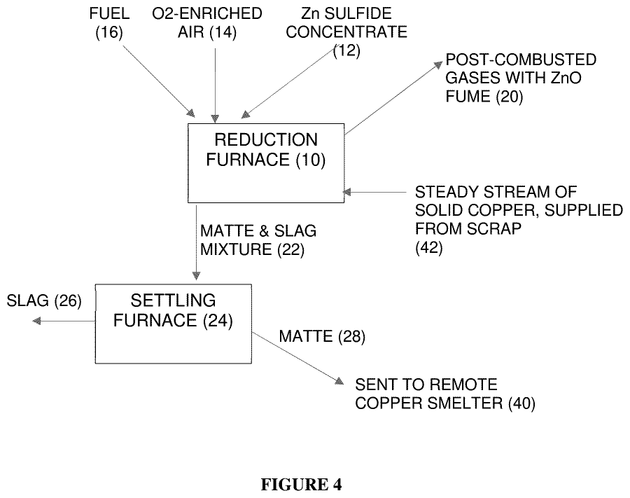

FIG. 4 shows a flowsheet of a method in accordance with another embodiment of the present invention. In FIG. 4, the reduction furnace 10, zinc sulfide concentrate 12, oxygen enriched air 14, and fuel 16 are essentially the same as described with reference to FIG. 3 and, for convenience, like reference numerals will be used to describe like features. As with FIG. 3, the mass flow rate of sulfur in the zinc sulfide is approximately one-third that of the mass flow rate of copper.

Similarly, a molten mixture of matte and slag 22 is removed from the furnace 10 and sent to a settling furnace 24 to enable the slag 26 to be separated from the matte 28. However, unlike the embodiment shown in FIG. 3, the copper-containing matte 28 is sent to a remote copper smelter 40, rather than being converted on site to blister copper for return to the reduction furnace 10.

In order to provide a steady supply of copper metal to the reduction furnace 10, a supply of scrap copper 42 is provided. The scrap copper 42 may be shredded and fed to the reduction furnace 10. Alternatively, the scrap copper 42 may be melted in a melting furnace and fed in a molten state to the reduction furnace 10.

In the embodiment shown in FIG. 4, the reduction furnace 10 assists in recycling scrap copper. One product of the process shown in FIG. 4 is the copper matte that can be sold to an existing copper smelter to form blister copper therefrom. The reduction furnace 10 shown in FIG. 4 may be operated under operating conditions that are largely the same as the operating conditions for the reduction furnace 10 shown in FIG. 3.

Optional embodiments may also be said to broadly include the parts, elements, steps and/or features referred to or indicated herein, individually or in any combination of two or more of the parts, elements, steps and/or features, and wherein specific integers are mentioned which have known equivalents in the art to which the invention relates, such known equivalents are deemed to be incorporated herein as if individually set forth.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

### Definitions

In describing and claiming the present invention, the following terminology will be used in accordance with the definitions set out below. It is also to be understood that the terminology used herein is for the purpose of describing particular embodiments of the invention only and is not intended to be limiting. Unless defined otherwise, all technical and scientific terms used herein have the same meaning as commonly understood by one having ordinary skill in the art to which the invention pertains.

The term “scrap copper” or “copper scrap” is intended to comprise both high grade and low grade copper scrap, for example, No. 1 and No. 2 copper scrap, auto-shred residue (ASR), waste electrical and electronic equipment, E-scrap, brass, bronze, No. 1 and No. 2 insulated wires, bare bright copper, copper alloy scraps and the like.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising”, “consisting of”, and “consisting essentially of”, where one of these three terms is used herein, the presently disclosed and claimed subject matter may include the use of either of the other two terms. Thus, in some embodiments not otherwise explicitly recited, any instance of “comprising” may be replaced by “consisting of” or, alternatively, by “consisting essentially of”.

Other than in the operating examples, or where otherwise indicated, all numbers expressing quantities of ingredients or reaction conditions used herein are to be understood as modified in all instances by the term “about”, having regard to normal tolerances in the art. The examples are not intended to limit the scope of the invention. In what follows, or where otherwise indicated, “%” will mean “weight %”, “ratio” will mean “weight ratio” and “parts” will mean “weight parts”.

The term “substantially” as used herein shall mean comprising more than 50% by weight, where relevant, unless otherwise indicated.

The term “about” should be construed by the skilled addressee having regard to normal tolerances in the relevant art.

The recitation of a numerical range using endpoints includes all numbers subsumed within that range (e.g., 1 to 5 includes 1, 1.5, 2, 2.75, 3, 3.80, 4, 5, etc.).

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

It must also be noted that, as used in the specification and the appended claims, the singular forms “a”, “an” and “the” include plural referents unless the context clearly dictates otherwise.

The prior art referred to herein is fully incorporated herein by reference unless specifically disclaimed.

Although example embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practiced or carried out in various ways.

1. A method for smelting a zinc sulfide concentrate, the method comprising the steps of:
feeding the zinc sulfide concentrate to a reduction furnace at a known mass flow rate of sulfur, wherein the furnace has a partial pressure of SO₂ maintained below about 10⁻³ atm;
feeding copper metal to the reduction furnace at a mass flow rate approximately three-times the mass flow rate of sulfur;
reducing the zinc sulfide to zinc; and
fuming the zinc;
wherein sulfur is absorbed into the copper metal in the reduction furnace to form a copper sulfide molten matte.

2. The method according to claim 1, wherein one or more precious metals in the zinc sulfide concentrate report to the copper sulfide molten matte and may be recovered in a respective one or more downstream processes.

3. The method according to claim 1, wherein the reduction furnace is operated at a temperature of less than about 1300° C.

4. The method according to claim 1, wherein the copper molten matte is removable from the reduction furnace.

5. The method according to claim 4, wherein the molten matte is refined in one or more copper converting furnace.

6. The method according to claim 5, wherein the one or more copper converting furnace regenerate copper metal for resupply to the reduction furnace.

7. (canceled)

8. The method according to claim 1, wherein the molten material in the reduction furnace further comprises slag.

9. The method according to claim 8, wherein the molten slag and molten matte are separated following extraction from the reduction furnace.

10. The method according to claim 9, wherein the molten slag and molten matte are separated in a settling furnace, the molten slag being removed from the settling furnace, and molten matte being sent to the one or more copper converting furnace.

11. The method according to claim 1, wherein at least some of the copper metal is provided from a supplementary source, wherein the supplementary source is copper scrap.

12. (canceled)

13. The method according to claim 12, wherein copper metal added to the reduction furnace is in the form of solid copper, molten copper, or a combination thereof.

14. The method according to claim 1, wherein the copper sulfide molten matte formed in the reduction furnace comprises about 65 to about 75 wt. % copper.

15. The method according to claim 1, wherein at least some of the lead present as PbS in the zinc sulfide concentrate reports to the molten matte.

16. (canceled)

17. (canceled)

18. The method according to claim 1, wherein the reduction furnace comprises a top-blown submerged-combustion lance furnace.

19. (canceled)

20. The method according to claim 1, wherein the reduction furnace is operated at an oxygen partial pressure between about 10^{-10.5} and about 10⁻⁹ atm.

21. The method according to claim 20, wherein air, oxygen, or oxygen-enriched air is added to the reduction furnace in stoichiometric ratios as may be required to maintain the furnace atmosphere with the oxygen partial pressure.

22. The method according to claim 8, wherein the slag comprises between 5 to 25 wt. % zinc when the slag leaves the reduction furnace.

23. The method according to claim 8, wherein the slag is suitable for further processing and recovery of zinc in a slag fuming furnace.

24. The method according to claim 1, wherein the zinc sulfide concentrate fed to the reduction furnace comprise
about 35 to about 60 wt. % zinc;
up to about 5 wt. % copper;
about 2 to about 15 wt. % lead;
about 2 to about 10 wt. % iron;
about 25 to about 35 wt. % sulfur;
up to about 3 wt. % calcium oxide;
about 2 to about 10 wt. % silica;
up to about 0.1 wt. % silver;
up to 0.01 wt. % gold; or
a combination thereof.

25. (canceled)

26. (canceled)

27. (canceled)

28. (canceled)

29. (canceled)

30. (canceled)

31. (canceled)

32. (canceled)

33. An apparatus for smelting a zinc sulfide concentrate by a method as defined according to claim 1, the apparatus comprising:
means for feeding the zinc sulfide concentrate to a reduction furnace at a known mass flow rate of sulfur;
means for feeding copper metal to the reduction furnace at a mass flow rate approximately three-times the mass flow rate of sulfur;
means for reducing the zinc sulfide to zinc; and
means for fuming the zinc;
wherein sulfur is absorbed into the copper metal in the reduction furnace to form a copper sulfide molten matte.

34. (canceled)

35. (canceled)

36. (canceled)

37. (canceled)

38. (canceled)

39. (canceled)

40. (canceled)
